(19) United States
(12) Patent Application Publication
(10) Pub. No.: US 2015/0215689 A1
(43) Pub. Date: Jul. 30, 2015

(54) MICROPHONE HOUSING ARRANGEMENT FOR AN AUDIO CONFERENCE SYSTEM

(71) Applicants: Klaus Hartung, Hopkinton, MA (US); Scot T. Armstrong, Merrimack, NH (US)

(72) Inventors: Klaus Hartung, Hopkinton, MA (US); Scot T. Armstrong, Merrimack, NH (US)

(21) Appl. No.: 14/324,835

(22) Filed: Jul. 7, 2014

Related U.S. Application Data
(60) Provisional application No. 61/931,882, filed on Jan. 27, 2014.

(51) Int. Cl. H04R 1/02; H04R 1/08

(52) U.S. Cl. CPC H04R 1/02; H04R 1/08; H04R 2499/10

(57) ABSTRACT

An audio conference system has a plurality of specially designed microphone housings into each of which a directional microphone is positioned. Each microphone housing is positioned entirely within the body of the audio conferencing system, the microphone housings are strategically positioned at each one of four corners of the audio conference system body in order to provide maximum exposure of a microphone to its operating environment, and the interior structure of the microphone housing is designing to reflect unwanted energy harmlessly away from the microphone. Each directional microphone is positioned in the microphone housing such that the most sensitive node in its polar response pattern is oriented normal (at right angles) to a line radiating outward from the center of the system.

### CROSS REFERENCE TO RELATED APPLICATIONS

This application claims the benefit under 35 U.S.C. §119(e) of U.S. Provisional Patent Application Ser. No. 61/931,882 entitled “MICROPHONE HOUSING ARRANGEMENT FOR AN AUDIO CONFERENCE SYSTEM”, filed Jan. 27, 2014, the entire contents of which is incorporated by reference.

### 1. BACKGROUND

A room audio system, such as a conference phone, can be used to conduct audio meetings between groups of participants that are remote with respect to each other. These devices allow the meeting participants to position themselves in a range of positions and orientations within a conference room or around a conference table in order to effectively participate in a conference call.

Among other things, conference phones or conference systems typically integrate loudspeakers into a housing with some number of microphones. Positioning a loudspeaker proximate to microphones creates a number of problems with respect to the capture and processing of audio signals (voice signals) from the local environment. The proximity of a loudspeaker to a microphone results in the microphone capturing energy from the loudspeaker (called acoustic coupling . . . far-end voice) which is then sent back as an acoustic echo to a far-end audio system where the participants hear their own voices as echo. This acoustic echo is distracting and denigrates the quality of an audio conferencing session. While it is possible to remove a certain amount of this acoustic echo in a microphone signal (maybe 25-30 db of acoustic echo energy) by applying acoustic echo cancellation (AEC) methods to the signal, the resulting audio signal can still include some acoustic echo energy.

One design technique that is typically used to mitigate the effects of acoustic coupling between a loudspeaker and microphone is to place the microphones as far away from the loudspeakers as is possible, and to position the microphones so that their positive polar pattern is oriented away (faces away) from the direction of loudspeaker energy waves. Typically, directional microphones are employed that exhibit a cardioid polar response pattern, where one side of the microphone is much less sensitive to acoustic energy than the other side. Moving microphones away from a loudspeaker and employing directional microphones further reduces the acoustic coupling between microphone and a loudspeaker proximate to them. A range of microphone polar response patterns are illustrated with reference to FIG. 1. Another advantage to the use of directional microphones is that they operate to pick up more of the direct sound waves and less of the reflected sound from the walls and ceiling than an omni-directional microphone. This makes the voices sound less reverberant and results in better intelligibility than with a single or multiple omnidirectional microphones. If directional microphones are used, typically a switching algorithm selects the microphone with the highest energy and mutes the remaining microphones.

Loudspeakers associated with audio conference systems are generally positioned at a central location with respect to the microphones comprising the audio system. Additionally, the microphones are typically located at the end of microphone arms that extend radially away from the central loudspeaker. The length of these microphone arms is dictated by the amount of echo return loss needed to provide a microphone signal that, after being processed, is relatively free from far-end voice energy. Alternatively, the entire body of an audio conference system can be extended laterally from a central loudspeaker location, and one or more microphones can be positioned at the outside radius or edges of the lateral body extension.

As described above, the directional microphones comprising an audio conference system are typically placed at the distal ends of these arms with respect to a central audio system location (loudspeaker position), and the microphones can be placed in a specially designed microphone housing that maximizes their exposure to a conference room environment while minimizing their exposure to loudspeaker energy. Such an audio conference phone arrangement is illustrated with reference to FIG. 2. As the directional microphones operate according to a pressure gradient difference between their front and back (as determined by their polar response pattern), anything that distorts this pressure gradient (reflected energy of any type) tends to reduce the directional characteristics of a microphone. It is critical to the operation of a directional microphone that the design of this microphone housing and placement of the microphone within the housing is affected as little as possible by reflected energy from the housing walls. Consequently, microphone housings are designed without side wall surfaces and with a back wall (behind the microphone) that is at least 2.5 cm away and sloped at an angle away from the microphone so that energy is reflected upward and away from the microphone.

### 2. BRIEF DESCRIPTION OF THE DRAWINGS

The present invention can be best understood by reading the specification with reference to the following figures, in which:

FIG. 1 illustrates a plurality of microphone polar response patterns.

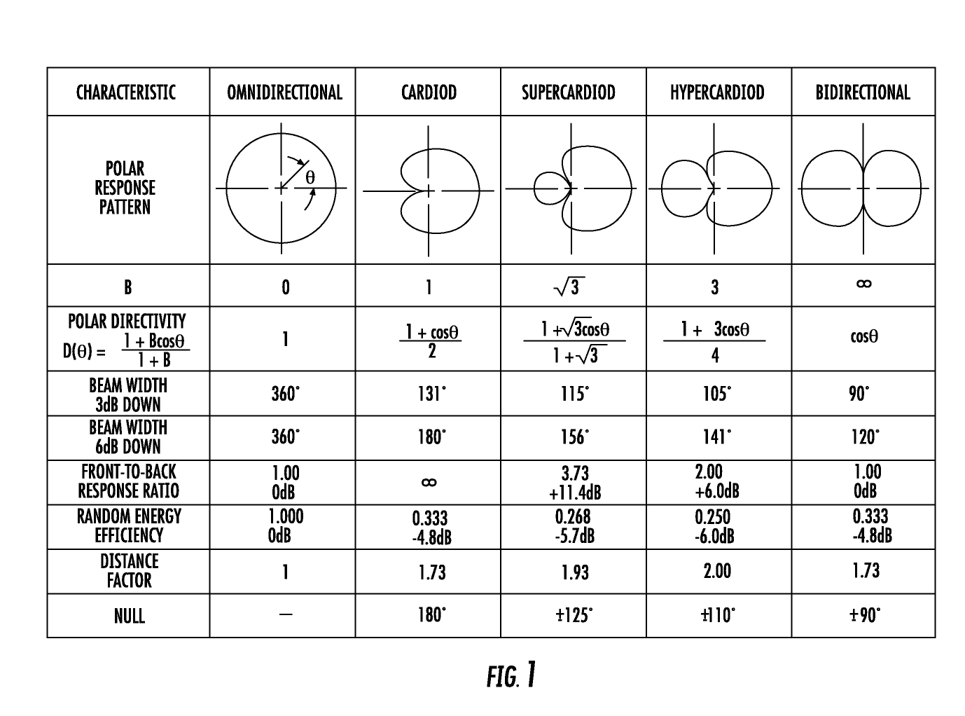

FIG. 2 is a drawing showing a prior art conference phone design with microphone arms.

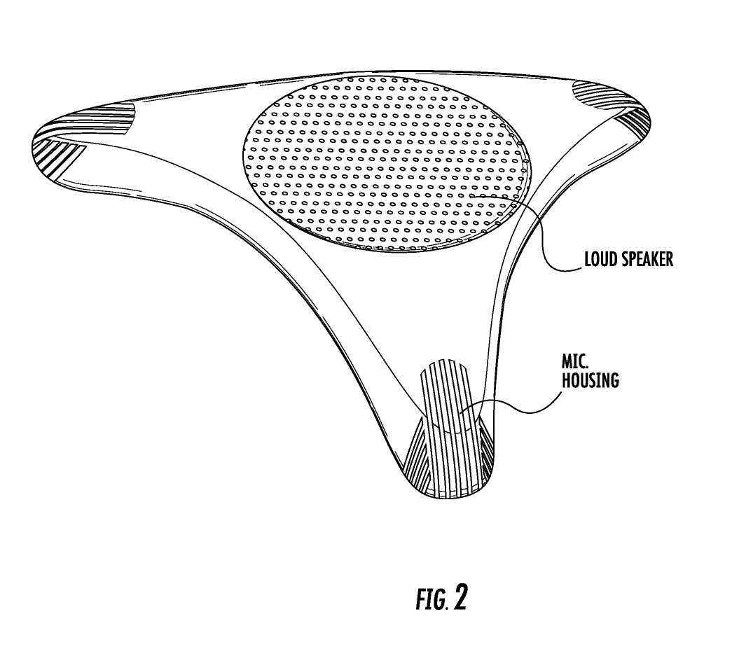

FIG. 3 is a drawing of a conference phone according to one embodiment.

FIG. 4 illustrates a perspective view of the conference phone of FIG. 3 without loudspeaker and microphone housing grills.

FIG. 5 is a drawing of the lower body cavity of the conference phone showing an embodiment of a microphone housing in vertical cross-section.

FIG. 6 is a graphical representation of a directional microphone polar response pattern.

FIG. 7 is a front view of another embodiment of a microphone housing.

FIG. 8 is a side view of the embodiment of FIG. 7.

### DETAILED DESCRIPTION

Although audio conference phones designed with microphone arms and housings that adequately expose directional microphones to their operating environment can operate to capture and process very high quality voice signals, the disadvantage with this type of design is that it has a relatively large table-top footprint. The smaller this footprint, the less obtrusive the audio conference system is, and the more room there is on the table for meeting materials used by the participants. It is possible to realize an audio conferencing system with a relatively smaller footprint if the microphone arms are eliminated from the design, but this requires that the directional microphones be positioned within the housing of the audio conference system, which can limit the exposure of the microphones to the acoustical operating environment in which they are intended to operate. Limiting a microphones exposure to their operating environment in this manner can alter the directional characteristics of the microphone such that they behave more like an omni-directional microphone, in which case acoustic coupling with a loudspeaker becomes much more prevalent and they can operate to capture much more unwanted environmental noise.

An audio conferencing system having a relatively small footprint is disclosed that does not need microphone arms or a laterally extended housing to move microphones away from a system loudspeaker. According to one embodiment, an audio conference system has a plurality of specially designed microphone housings an acoustic opening or port and an acoustic reflective surface into which is placed a directional microphone. Each microphone housing is positioned to be substantially entirely within an audio conferencing system housing, and a set of two or more microphone housings are strategically positioned around the circumference of the audio conference system in order to provide maximum exposure of the microphone set as a whole to acoustic environment in which the audio conference system is operating. Each microphone housing has an acoustic reflective surface that is designing with a geometry that reflects unwanted or reflected acoustic energy away from the microphone, and to provide both sides of a transducer comprising each directional microphone in the set of microphones with substantially unobstructed exposure (no acoustical barrier) to the acoustic environment with respect to a polar response pattern associated with the directional microphone.

Further, each directional microphone is positioned in a microphone housing such that a ray extending through the zero degree (0°) point in the microphone's polar response pattern is oriented substantially normal (at right angles) to an axis extending from the microphone through a center point in the audio conference system to a point on an opposite side of the system housing. A directional microphone oriented in this manner in such a specially designed microphone housing exhibits good directional operating characteristics and the acoustic coupling between the speaker and microphone is low enough so that the signal can be easily processed to remove any acoustic echo present.

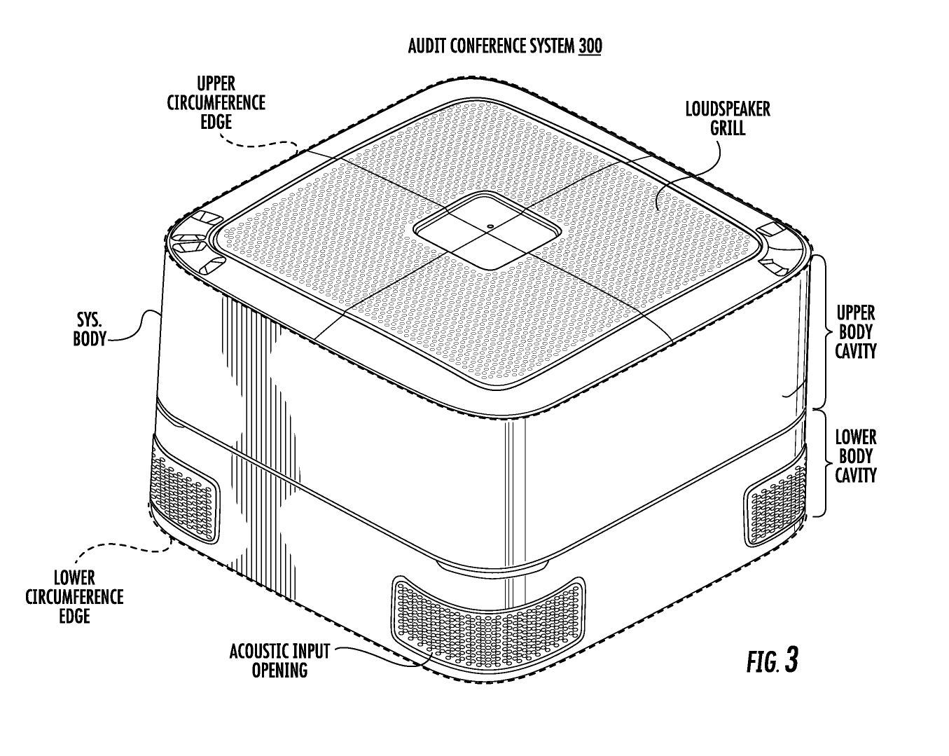

An audio conference system 300 having a relatively small footprint according to one embodiment is illustrated with reference to FIG. 3. The audio conference system 300 shown here has a relatively small footprint when compared to prior art audio conference systems or phones. This small footprint is at least in part achieved by eliminating the microphone arms and integrating the microphones into the audio conference system housing without laterally extending the system housing. One embodiment of the audio conference system 300 is illustrated as being cubic in shape with an upper body housing cavity and a lower body housing cavity. Other embodiments can assume a round shape or can have more or fewer than four sides. The upper body housing cavity of system 300 is comprised of a top surface (below a grill), that can be square and substantially horizontally oriented, and four substantially vertical side wall surfaces all of which can be substantially flat. The peripheral portion of the top surface is defined by an upper circumferential edge and one or more loudspeakers can be mounted on the top surface of the upper body cavity of the audio conference system. These loudspeakers are oriented in an upward direction behind the speaker grill. The top surface area need be only large enough to accommodate the number of loudspeakers comprising the system and in this regard the size of the loudspeakers directly impacts the footprint of the audio conference system. The lower body cavity of the audio conference system provides a physical barrier between the loudspeakers in the upper body cavity, serves as an enclosure for electronics associated with the audio conferencing system and supports separate housings for each of four directional microphones. Each microphone is positioned in a microphone housing that is located behind a microphone grill which is composed of a suitable acoustically transparent material. While the audio conference system described with reference to FIG. 3 has four microphone housings positioned at each of the four corners of the system, the system can, depending upon the system shape or other considerations, be implemented with fewer than four microphone housings.

The microphone housings are positioned proximate to a lower circumferential edge of the lower body cavity. The location of the housings (and therefore the microphones) positions them a maximum distance from the loudspeakers, which has the effect of minimizing the acoustic coupling between the loudspeaker and the microphones. However, the directional characteristics (polar response pattern) of a microphone can be distorted if it is placed into a microphone housing that is not designed to reflect unwanted acoustic energy away from the microphone. This distortion can be manifested by the microphone exhibiting characteristics that are more omni-directional than directional in nature. If the microphone behaves in an omni-directional manner, it is likely to capture unwanted environmental acoustic energy (noise, speaker reflection/refraction, etc.) in addition to voice signals, and this unwanted energy can denigrate both the operation of a microphone selection algorithm and an acoustic echo cancellation function. The audio conference system 300 of FIG. 3 can be either a room audio system or it can be an audio conference system, but for the purpose of this description, is referred to here as audio system 300.

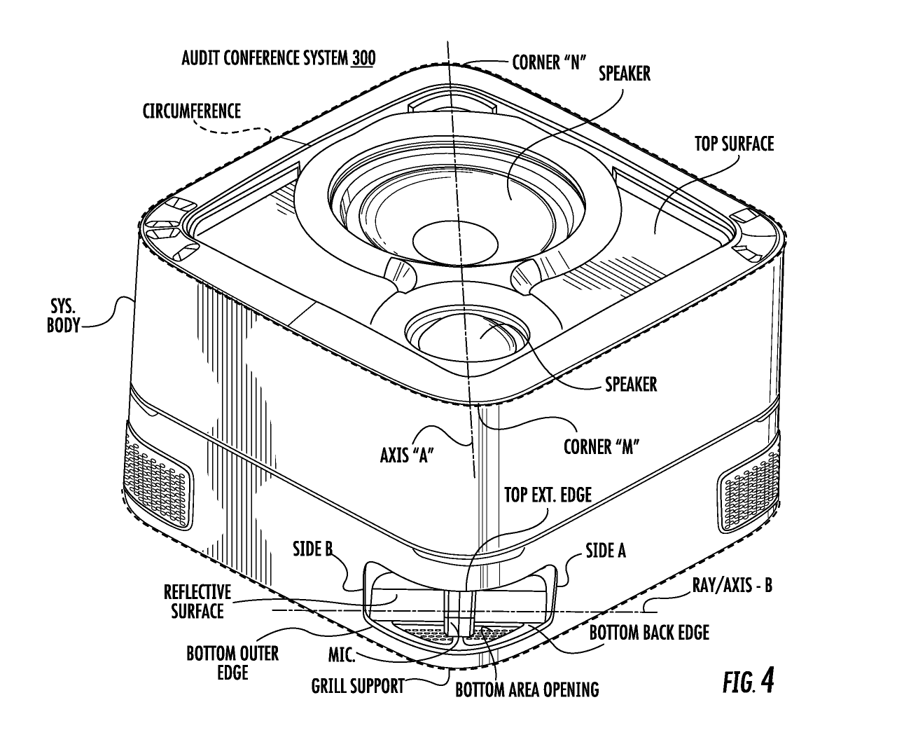

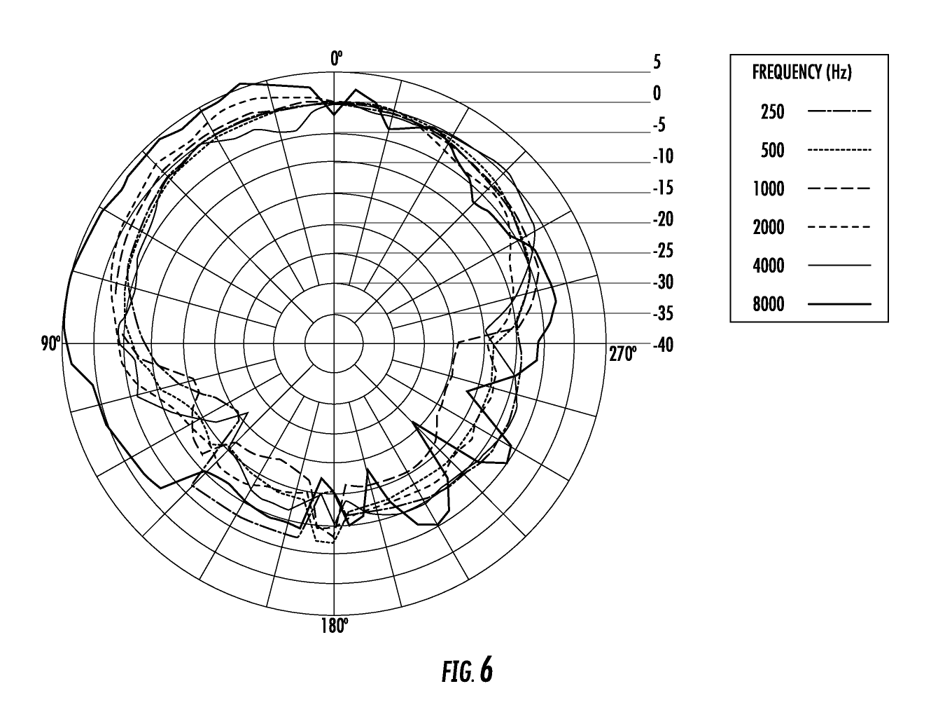

FIG. 4 shows the audio system 300 of FIG. 3 with the loudspeaker grill and one microphone grill removed. According to this embodiment, each one of four directional microphones is positioned in a separate microphone housing. Each microphone housing is substantially triangular in shape when viewed in horizontal cross section, the entire front area or acoustic port comprising the microphone housing is open to the local acoustic environment, and this acoustic port comprises a portion of the area that would otherwise comprise portions of two lower cavity side walls. The microphone housing acoustic port is circumscribed by a top external edge, two side edges A and B, and a bottom external edge (optional). The bottom area of the acoustic port comprising the microphone housing is substantially open to a surface (i.e., conference table top) upon which the audio system 300 rests, and a comprising substantially a entire interior surface of the microphone housing is specially designed to both reflect unwanted environmental acoustic energy away from a directional microphone and to not be an acoustical barrier between the microphone and the acoustical environment that attenuates a polar response pattern associated with the microphone. A directional microphone is shown positioned in a central location within the microphone housing, and it is oriented, as previously described, such that the ray extending from the microphone to the zero degree (0°) point in the microphone's polar response pattern is oriented normal (at right angles) to an axis-A extending from the microphone through a center point in the audio conference system to a point on an opposite side of the system housing. This microphone housing design in combination with the microphone orientation within the housing maximizes the microphones exposure to its acoustic operating environment, and at the same time preserves its directional operating characteristics by minimizing its exposure to reflected acoustic energy. The operating characteristics of a directional microphone positioned in such a microphone house are illustrated with reference to FIG. 6.

FIG. 6 is a graphical representation of a polar response pattern associated with the directional microphone in the microphone housing described with reference to FIG. 4. Microphone sensitivity measurements are shown on the graph for frequencies at 250, 500, 1000, 2000, 4000 and 8000 hertz. While there is some loss of microphone sensitivity at the 8000 hertz frequency, there is no substantial loss of sensitivity at the lower frequencies in the polar direction of interest.

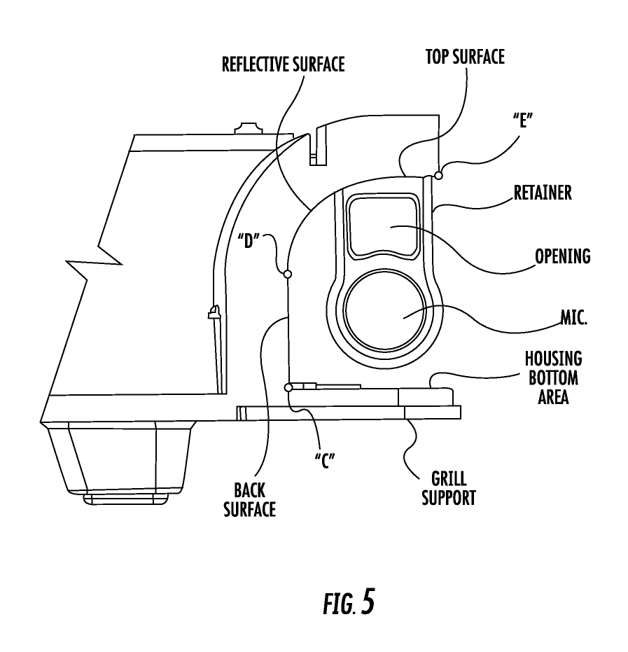

Continuing to refer to FIG. 4, the acoustic reflective surface comprising substantially the entire interior surface of the microphone housing is comprised of a back wall or surface portion that transitions vertically upward to a curved surface portion which continues to a top surface portion. This reflective surface can extend in a straight line from side A of the microphone housing to side B of the microphone housing, and it can extend from the top external edge of the microphone housing to the rear or back bottom edge of the microphone housing. The microphone housing acoustic reflective surface, according to this embodiment, is substantially parallel over its entire surface area with respect to an axis B (which comprises the ray associated with the microphone polar response pattern and an extension of the ray 180° in the opposite direction) and the surface is straight when viewed in horizontal cross section from one side (side A) of the microphone housing to the other side (side B). Further, this reflective surface is specially designed such that its profile is curved when viewed in vertical cross section (see FIG. 5) from the top external edge to the bottom back edge of the microphone housing. According to the embodiment illustrated in FIG. 5, the vertical cross sectional profile of the acoustic reflective surface is substantially straight from point C, at the bottom back edge, to point D, which is located at approximately the midpoint of the back surface portion of the housing. Above the midpoint in the back surface, the profile assumes a curved or arcuate shape having a radius that is selected to reflect unwanted environmental acoustic energy away from the directional microphone. This curve can extend to the top external edge of the microphone housing or nearly to the top external edge of the housing at a point labeled E.

As described earlier, and as shown in FIG. 4, substantially the entire bottom area of the microphone housing is open to the surface upon which the audio system is resting, and this bottom area can have a bottom/front microphone grill support member (optional) that extends laterally from and horizontal to the two bottom edges of the corresponding lower cavity side walls. While the embodiment described here with reference to FIG. 5 has a bottom grill member, it should be understood that this grill member is not an essential to the operation of this invention. The purpose of this opening is to provide an egress from the housing for acoustic energy reflected downward by the acoustic reflective surface.

As illustrated in FIGS. 4 and 5, the directional microphone is placed at an optimal position and orientation within the microphone housing to capture direct (unreflected) acoustic energy (voice) generated by meeting participants. The directional microphone is connected to a microphone retaining member that subtends from the top portion of the acoustic reflective surface comprising the microphone housing. The microphone retaining member is composed of a flexible, rubber-like material that has the property of absorbing vibrations so that they are not transmitted from the acoustic reflective surface to the microphone. The microphone retainer member has a window that functions to permit acoustic energy that enters the housing to pass through without being reflected from the retainer. The purpose of the retainer member design is to hold the directional microphone in position within the housing while having a minimal surface area from which acoustic energy can reflect.

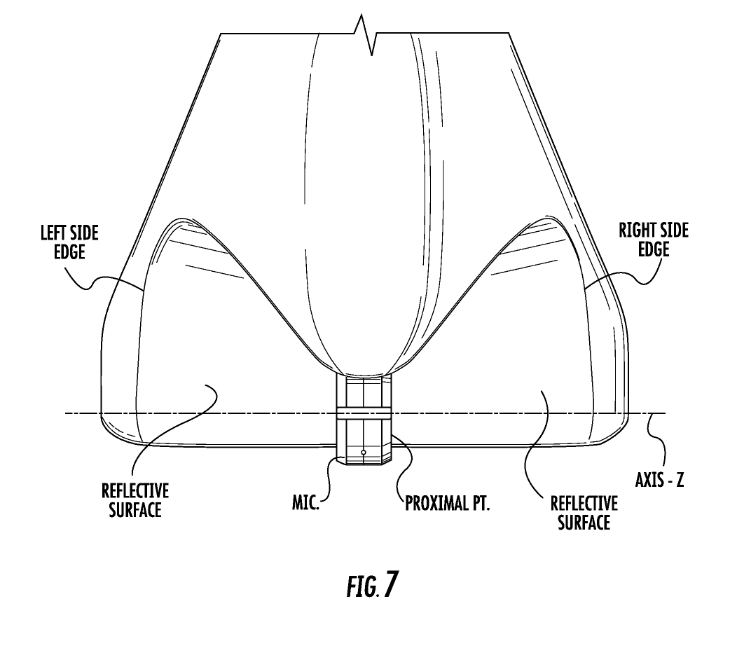

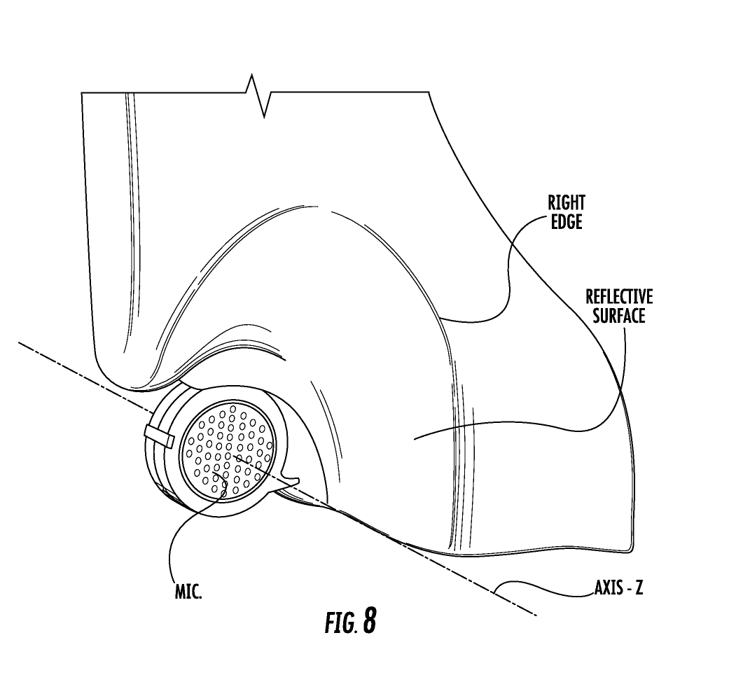

The horizontal and vertical cross sectional profiles of the acoustic reflective surface are not limited to the embodiment described with reference to FIGS. 4 and 5. Depending upon the need to reflect more acoustic energy away from the microphone and/or to expand a microphones exposure to acoustic environment (in order to increase higher frequency sound fidelity), other embodiments of a microphone housing acoustical port and reflective surface can exhibit a more complex geometry. According to an embodiment of a microphone housing illustrated in FIGS. 7 and 8, a vertical cross section of an acoustic reflective surface that is normal to an axis z running through the center of a microphone positioned in the housing is arcuate in shape from a left to a right side edge of the waveguide. A measured radial dimension or distance of the acoustic reflective surface in a vertical cross section located proximal to the microphone is relatively smaller than a measured radial dimension or distance of the acoustic reflective surface in a vertical cross section located at right and left edges of the acoustic reflective surface as shown in FIGS. 7 and 8. The measured radial dimension of the waveguide surface can increase either linearly or non-linearly from the point proximal to the microphone to either of the right or left distal ends or edges of the acoustic reflective surface.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. An audio conference system, comprising:
one or more microphone housings positioned around a circumference of the audio conference system, each microphone housing has an acoustic port and an acoustic reflective surface; and
a directional microphone in the microphone housing oriented such that a ray passing through a zero degree point in a polar response pattern of the microphone is substantially normal to a horizontal axis that extends from the microphone, through a central point of the audio conference system to a point located on the opposite side of the audio conference system housing circumference.

2. The audio conference system of claim 1, further comprising a geometry of the microphone housing acoustic port and acoustic reflective surface not presenting an acoustical barrier which substantially attenuates a polar response pattern associated with a directional microphone in the microphone housing over the operating frequency range of the directional microphone.

3. The audio conference system of claim 2, further comprising the acoustic reflective surface geometry reflecting acoustic energy entering the microphone housing away from the directional microphone.

4. The audio conference system of claim 1, where the polar response pattern of the directional microphone is a cardioid response pattern.

5. The microphone housing of claim 1, further comprising the directional microphone being retained in the microphone housing by a member that subtends from the acoustic reflective surface.

6. The microphone housing of claim 5, wherein the directional microphone retaining member displays a minimal profile to acoustic energy entering the microphone housing.

7. The microphone housing of claim 1, wherein the acoustic port is substantially open to the surface upon which the audio conference system rests.

8. The microphone housing of claim 1, wherein the acoustic reflective surface is substantially arcuate shaped when viewed in a vertical cross section that is normal to an axis intersecting the center of and normal to the directional microphone.

9. A method for detecting acoustic energy, comprising:
positioning a directional microphone in a microphone housing located on a circumference of an audio conference system such that a ray passing through a zero degree point in a polar response pattern of the directional microphone is substantially normal to a horizontal axis that extends from the directional microphone, through a central point of the audio conference system to a point located on the opposite side of the audio conference system housing circumference.

10. The audio conference system of claim 9, further comprising geometry of the microphone housing acoustic port and acoustic reflective surface not presenting an acoustical barrier which substantially attenuates a polar response pattern associated with a directional microphone in the microphone housing over the operating frequency range of the directional microphone.

11. The audio conference system of claim 10, further comprising the geometry of the acoustic reflective surface reflects acoustic energy entering the housing away from the directional microphone.

12. The audio conference system of claim 9, where the polar response pattern of the directional microphone is a cardioid response pattern.

13. The microphone housing of claim 9, further comprising the directional microphone being retained in the microphone housing by a member that subtends from the acoustic reflective surface.

14. The microphone housing of claim 13, wherein the directional microphone retaining member displays a minimal profile to acoustic energy entering the microphone housing.

15. The microphone housing of claim 9, wherein the acoustic port is substantially open to the surface upon which the audio conference system rests.

16. The microphone housing of claim 9, wherein the acoustic reflective surface is substantially arcuate shaped when viewed in a vertical cross section that is normal to an axis intersecting the center of and normal to the directional microphone.
